(19) United States
(12) Patent Application Publication
(10) Pub. No.: US 2018/0070557 A1
(43) Pub. Date: Mar. 15, 2018

(54) FEEDING APPARATUS

(71) Applicant: The Brodie Bowl, LLC, Myrtle Beach, SC (US)

(72) Inventor: Brian Uhl, Myrtle Beach, SC (US)

(73) Assignee: The Brodie Bowl, LLC, Myrtle Beach, SC (US)

(21) Appl. No.: 15/693,689

(22) Filed: Sep. 1, 2017

Related U.S. Application Data
(60) Provisional application No. 62/394,566, filed on Sep. 14, 2016.

(51) Int. Cl. A01K 5/01; F16M 11/04; F16M 11/32; F16M 11/10; A01K 7/00

(52) U.S. Cl. CPC A01K 5/0114; F16M 11/046; A01K 7/00; F16M 11/10; F16M 11/32

(57) ABSTRACT

A feeding apparatus for allowing an animal to eat and/or drink from a position at which the animal's spine and/or esophagus is aligned. The feeding apparatus includes a vertically adjustable feeding platform having a feeding surface from which an animal may eat and/or drink and may be oriented at an angle relative to the surface of the ground on which the feeding apparatus is placed. The feeding apparatus includes a vertically adjustable first platform located below the feeding platform and providing a paw surface on which an animal may place its front feet when eating and/or drinking from the feeding platform, the paw surface being located above the surface of the ground on which the feeding apparatus is placed. The feeding apparatus includes a member adjustably connected to the vertically adjustable feeding platform, the member supporting the vertically adjustable feeding platform and providing for vertical adjustment of the feeding platform.

### REFERENCE TO RELATED APPLICATION

This application claims priority to U.S. Provisional Patent Application No. 62/394,566 filed on Sep. 14, 2016, the entire contents of the provisional application being incorporated herein by reference.

### BACKGROUND

Many people have animals (e.g. cats, dogs, horses, cattle, etc.) that they feed from bowls, or other containers, that are placed directly on the ground and/or are elevated from the ground. Some animals have conditions (e.g. megaesophagus, gastric dilation volvulus aka “twisted stomach,” cervical spondylomyelopathy aka “wobblers syndrome,” etc.) that make it painful and/or harmful for the animal to eat and/or drink from containers placed on the ground and/or when the angle of the animal's spine is not aligned so that gravity assists the animal with the digestion process. For example, for animals suffering from megaesophagus, the misalignment caused by this condition may result in food being consumed and/or regurgitated by the animal to be drawn into the lungs resulting in illness or death. The optimal feeding position for many animals is when the spine is aligned so the animal's food and/or drink may be easily digested (i.e. the mouth and/or esophagus is located above the stomach). When an animal eats from this position, the animal's digestion may improve, the animal's regurgitation and flatulence may be reduced and/or one or more of the animal's conditions may be treated.

To currently address the problem of placing animal feeding containers on the ground, many individuals elevate the containers so that the animal does not have to bend over to access the feeding containers. However, commercially available feeding container elevators may not adjust to the correct height for the animal for which the feeding container elevator was purchased. Further, commercially available feeding containers generally include horizontal feeding surfaces, which require the animal to tilt its head downward to access the food and/or drink, which causes a spinal misalignment. Further still, commercially available feeding containers may also require the animal to stand on the ground while eating and/or drinking, which does not place the animal's spine at the appropriate angle for gravity to assist with the digestion process. What is needed is a feeding apparatus that allows an animal to eat and/or drink from a position that places the animal's spine at an angle which utilizes gravity to assist with digestion, which may eliminate or reduce the severity of the above-identified conditions.

### SUMMARY

According to an implementation, described herein, a feeding apparatus for allowing an animal to eat and/or drink from a position at which the animal's spine and/or esophagus is aligned may include a vertically adjustable feeding platform having a feeding surface from which an animal may eat and/or drink. The feeding surface may be oriented at an angle relative to the surface of the ground on which the feeding apparatus is placed to prevent the animal from looking down and/or to cause the animal to tilt its head back when eating and/or drinking from feeding apparatus. The feeding apparatus may also include a vertically adjustable first platform located below the feeding platform and providing a paw surface on which an animal may place its front feet when eating and/or drinking from the feeding platform. The paw surface may be located above the surface of the ground on which the feeding apparatus is placed. The feeding apparatus may further include a member adjustably connected to the vertically adjustable feeding platform, the member supporting the vertically adjustable feeding platform and providing for vertical adjustment of the vertically adjustable feeding platform. The feeding apparatus may further include legs connected to the vertically adjustable first platform, the legs providing for vertical adjustment of the vertically adjustable first platform. The legs may be telescoping, removable, formed from at least two pieces, etc. The feeding apparatus may further include a vertically adjustable first platform having an accordion-style design. The member may be connected to the feeding platform. The angle may be fixed or adjustable and may be from about 5 degrees to about 25 degrees, preferably from about 8 degrees to about 18 degrees, more preferably from about 10 degrees to about 16 degrees. The feeding apparatus may further include one or more feeding apertures located on the feeding surface, namely two apertures. The feeding apparatus may further include only one member, which may be located between the two feeding apertures. The feeding apparatus may further include a second platform located the surface of the ground on which the feeding apparatus is placed.

According to another implementation, described herein, a feeding apparatus for allowing an animal to eat and/or drink from a position at which the animal's spine and/or esophagus is aligned may include a vertically adjustable feeding platform having a feeding surface from which an animal may eat and/or drink, the feeding surface being oriented at a fixed angle relative to the surface of the ground on which the feeding apparatus is placed to prevent the animal from looking down and/or cause the animal to tilt its head back when eating and/or drinking from feeding apparatus. The feeding apparatus may further include a first platform located below the feeding platform and providing a paw surface on which an animal may place its front feet when eating and/or drinking from the feeding platform. The paw surface may be located above the surface of the ground on which the feeding apparatus is placed. The feeding apparatus may further include a member adjustably connected to the vertically adjustable feeding platform, the member supporting the vertically adjustable feeding platform and providing for vertical adjustment of the vertically adjustable feeding platform. The fixed angle may be from about 5 degrees to about 25 degrees, preferably from about 8 degrees to about 18 degrees, more preferably from about 10 degrees to about 16 degrees.

According to another implementation, described herein, a feeding apparatus for allowing an animal to eat and/or drink from a position at which the animal's spine and/or esophagus is aligned may include a vertically adjustable feeding platform having a feeding surface from which an animal may eat and/or drink. The feeding surface may be oriented at an angle relative to the surface of the ground on which the feeding apparatus is placed to prevent the animal from looking down and/or cause the animal to tilt its head back when eating and/or drinking from feeding apparatus. The feeding apparatus may further include a first platform located below the feeding platform and providing a paw surface on which an animal may place its front feet when eating and/or drinking from the feeding platform. The paw surface may be located above the surface of the ground on which the feeding apparatus is placed. The feeding apparatus may further include a single member adjustably connected to the vertically adjustable feeding platform, the single member supporting the vertically adjustable feeding platform and providing for vertical adjustment of the vertically adjustable feeding platform. The feeding apparatus may further include two feeding apertures located on the feeding surface. The single member may be located between the feeding apertures.

### BRIEF DESCRIPTION OF THE DRAWINGS

FIGS. 1A and 1B illustrate a perspective view and a side view, respectively, of a non-limiting example embodiment of a feeding apparatus.

FIG. 2 illustrates an alternative non-limiting example embodiment of a feeding apparatus.

FIG. 3 illustrates another alternative non-limiting example embodiment of a feeding apparatus.

### DETAILED DESCRIPTION

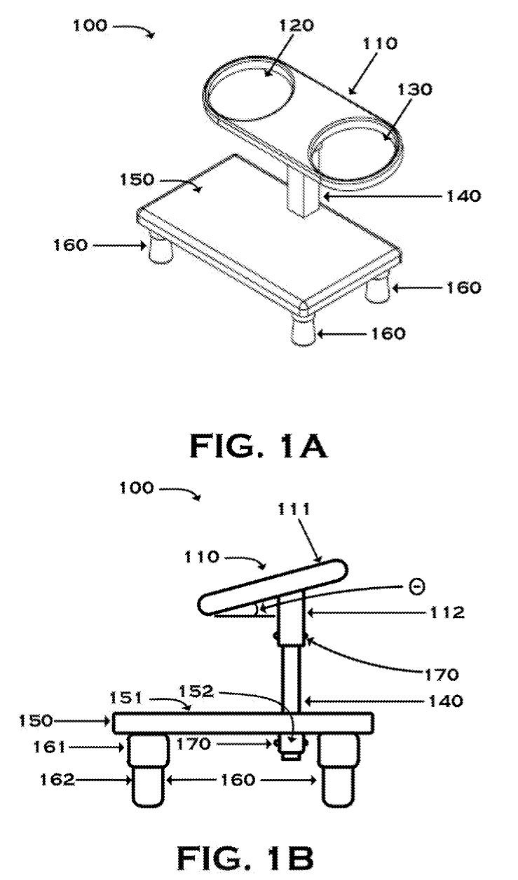

FIGS. 1A, 1B, 2 and 3 are attached hereto and incorporated by reference herein. The following detailed description refers to FIGS. 1A, 1B, 2 and 3. The same reference numbers in different figures may identify the same and/or similar elements.

A device, apparatus, system and/or technology, as described herein (the “technology”), may include a feeding apparatus that may provide a paw surface, a feeding surface and/or feeding containers for a variety of animals (e.g. cats, dogs, horses, cattle, etc.) of different shapes and sizes and/or that may permit the animals to eat and/or drink from position in which the animal's spine is oriented at an angle (e.g. 1 degree, 60 degrees, etc.) that promotes digestion and/or eliminates pain or discomfort associated with conditions described herein. The animal's spine may be properly oriented when the spinal column is aligned in a manner that avoids or reduces the symptoms associated with one or more conditions (e.g. megaesophagus, gastric dilation volvulus aka “twisted stomach,” cervical spondylomyelopathy aka “wobblers syndrome,” etc.) suffered by the animal. The feeding apparatus may be adjustable to properly orient the animal's spinal column and/or esophagus such that the spine and/or esophagus are generally oriented downward from mouth to stomach and/or do not have any sections in which the spine and/or esophagus trends bends upward to limit and/or slow food and/or drink passing from the mouth to the stomach. The feeding apparatus may provide a feeding platform from which an animal may eat and/or drink. The feeding apparatus may also include one or more platforms on which the animal may place its feet (e.g. front and/or back feet, paws, hooves, etc.) when the animal eats and/or drinks from the feeding platform. The feeding platform and/or platforms may be adjusted (e.g. moved horizontally, vertically, and/or rotated in yaw, elevation and/or roll angle) so that the animal's spine is oriented to promote digestion when it eats from feeding platform. Additionally, or alternatively, the feeding platform be secured to the feeding apparatus such that a feeding surface is provided at a fixed angle relative to the ground and/or a surface on which the feeding apparatus is placed, which may align an animal's spine and may also prevent the feeding platform from becoming misaligned (e.g. by the animal when eating, etc.). Eating from a position in which the animal's spine is aligned in this fashion may help the animal digest its food better, may reduce regurgitation and/or flatulence, may treat one or more symptoms associated with a condition (e.g. megaesophagus, gastric dilation volvulus aka “twisted stomach,” cervical spondylomyelopathy aka “wobblers syndrome,” etc.) suffered by the animal, etc. For example, alignment of the spine and/or esophagus may allow food and/or liquid to travel from the mouth to the stomach along an esophagus that is generally in a straight line and travels downward to the stomach. In this orientation, the food and/or liquid travels easily to the stomach with the assistance of gravity.

FIGS. 1A and 1B illustrate a non-limiting example embodiment of a feeding apparatus 100 in which the technology provided herein may be implemented. As shown in FIGS. 1A and 1B, feeding apparatus 100 may include feeding platform 110, a first feeder 120, a second feeder 130, a member 140, a platform 150 and one or more legs 160 (referred to individually as “leg 160” or collectively as “legs 160”). The components illustrated in FIGS. 1A and 1B are provided for explanatory purposes only, and the disclosure herein is not intended to be limited to the components provided therein. There may be additional components, fewer components, different components, or differently arranged components than illustrated in FIGS. 1A and 1B. Also, in some implementations, one or more of the components of the feeding apparatus 100 may perform one or more functions described as being performed by another one or more of the components of the feeding apparatus 100.

Feeding platform 110 may provide an elevated feeding surface 111 (e.g. elevated from platform 150 and the surface (e.g. ground, floor, etc.) on which feeding apparatus 100 is placed) from which an animal may eat or drink. Feeding surface 11 may correspond to a surface from which an animal may eat or drink. For example, and not limitation, feeding platform may include a first feeder 120 and/or a second feeder 130. First feeder 120 and/or second feeder 130 may correspond to apertures through within which a feeding and/or drinking dish (e.g. a bowl, such as a standard (1 quart, 2 quart, 3 quart, etc.) bowl used for pets, etc.) may be placed. Additionally, or alternatively, first feeder 120 and/or second feeder 130 may include receptacles that may hold food and/or liquids for an animal to eat and/or drink and may be formed as a part of feeding platform 110. While feeding platform 110 provides two feeders, there may be fewer feeders or more feeders. Additionally, or alternatively, a user of feeding apparatus 100 may place food for an animal and/or a container containing food and/or liquids for an animal directly on feeding surface, eliminating the need for the feeders.

Feeding platform 110 may provide feeding surface 111 at an angle Θ relative to platform 150 and/or the surface of the ground (e.g. the ground, the floor of a home, etc.) on which feeding apparatus 100 is placed. Angle Θ may correspond to an angle more than zero degrees that aligns the esophagus and/or spinal column of an animal that eats or drinks from feeding apparatus 100. Providing feeding surface 111 at an angle Θ may prevent the animal from looking down and/or cause the animal to tilt its head back when eating and/or drinking from feeding apparatus, which may properly align the esophagus and/or spine of the animal such that the food and/or liquid consumed by the animal travels from the mouth to the stomach more easily. Angle Θ may be, for example, 5 degrees to 25 degrees, preferably 8 degrees to 18 degrees, more preferably 10 degrees to 16 degrees. Angle E may be fixed (i.e. not adjustable) or may be adjustable, such as described further herein. Angle E may be a fixed angle to prevent, for instance, unwanted adjustment of angle Θ (e.g. such as by an animal when eating and/or drinking from feeding apparatus 100, etc.), which may limit and/or prevent food and/or liquid being spilled from feeding apparatus 100.

Feeding platform 110 may be connected to member 140. The connection between feeding platform 110 and member 140 may be a fixed connection (e.g. welded, formed as a part of, glued, fastened, etc.) and/or may be an adjustable connection. For example, and not limitation, as shown in FIGS. 1A and 1B, the adjustable connection may include a pinned connection in which member 140 is slidably engaged with a collar 112 connected to and extending from feeding platform 110. A pin 170 passes through apertures in collar 112 and member 140 to set the vertical position of feeding platform 110 along member 140. Member 140 and/or feeding platform 110 may include multiple apertures to allow a user to adjust the position of feeding platform 110 adjusting the placement of pin 170 in the apertures located in member 140 and/or collar 112. In this embodiment, member 140 is shown as a vertical member, so adjusting the position of feeding platform 110 relative member 140 may adjust the height of feeding platform 10. Additionally, or alternatively, member 140 may be oriented at an angle from vertical, in which case a slideable connection would adjust along the member. Additionally, or alternatively, member 140 and feeding platform 110 may be rotatably connected (e.g. a pin connection that is not prevented from rotating via a slidable connection, a bearing, a hinge and set pin, etc.) such that the connection between member 140 and feeding platform 110 may allow a user to adjust angle (via this connection. Some rotatable adjustments may include a retainer (e.g. a clamp, a fastener, a pin, etc.) that may be engaged to set the angle Θ of the feeding surface 11. Alternatively, the connection between member 140 and feeding platform 110 may not allow for any rotation such that angle Θ is fixed. When angle Θ is fixed, an animal may not be able to accidentally adjust angle Θ, such as when eating and/or drinking from feeding apparatus 100. Additionally, providing a fixed angle Θ may decrease the manufacturing costs associated with feeding apparatus 100 by eliminating the cost one adjustable connection.

Member 140 may connect to feed platform 110 and/or to platform 150 to extend feed platform 110 above platform 150, such as described above. Additionally, or alternatively, member 140 may connect to platform 150 in the same and/or similar ways as member 140 connects to feed platform 110. Additionally, or alternatively, member 140 may not connect to platform 150 but, instead, may support feed platform 110 without a connection with platform 150, such as by having legs, etc. that independently support feed platform 110 and member 140. In this configuration, the feed platform 110 and platform 150 are associated with each other such that an animal may place its front feet/paws on the platform 150 and may eat/drink from the feed platform 110. In the embodiment depicted in FIGS. 1A and 1B, the connection between member 140 and platform 150 may include a pin 170 and platform collar 152 which may provide a pinned, slidable connection that allows the a user to raise and/or lower feeding platform 110 relative to platform 150, such as to align the spinal column of an animal. FIGS. 1A and 1B provide a “single member” design in which single member 140 supports the feeding platform 110 and/or connects feeding platform 110 to platform 150. Using only a single member 140 in this manner may reduce the manufacturing costs associated with feeding apparatus 100. Additionally, or alternatively, using only a single member 140 may provide easier and/or more convenient access to the feeding surface 111 by the animal. For example, providing a single member 140 to support feeding platform 110 between first feeder 120 and second feeder 130 may locate the member 140 between the legs and/or feet of an animal feeding and/or drinking from feeding platform 110. In this configuration, the animals legs and/or feet may not interfere with member 140 when the animal is eating and/or drinking from feeding platform 110. Also, or alternatively, this configuration may allow adjustment of the angle Θ at only the connection between the member 140 and the feeding platform 110. Additionally, or alternatively, feeding apparatus 100 may include more than one (2, 3, 4, etc.) members 140, which may make feeding platform 110 more stable than a single member 140.

Platform 150 may provide a paw surface 151 between the feeding surface 111 and the surface (e.g. floor/ground, etc.) on which feeding apparatus 100 is placed. An animal may place its front feet/paws/hooves, etc. on paw surface 151 while eating and/or drinking from feeding platform 110 of feeding apparatus 100. By placing its front paws on paw surface 151, an animal may cause its spine and/or esophagus to be aligned in a way that makes eating and/or drinking easier and/or relieves one or more of the conditions referenced herein. Platform 150 may provide paw surface 151 at a height above the surface on which feeding apparatus 100 is placed such that when an animal places its front feet/paws/hooves, etc., the animal's spine and/or esophagus is properly aligned for eating, drinking, digestion, etc. Platform 150 may provide paw surface 151 at this height by, for instance, the thickness of the material from which platform 150 is made, etc. Additionally, or alternatively, the height of paw surface 151 may be determined by the height of legs, such as legs 160, that elevate platform 150 from the surface on which the feeding apparatus 100 is placed. Additionally, or alternatively, platform 150 may be vertically adjustable (e.g. collapsible, adjustable legs, etc.) to adjust the height at which paw surface 151 is located. Adjusting the height at which paw surface 151 is located may allow feeding apparatus 100 to be adjusted for different size animals. For example, a large animal may need to place its front feet/paws/etc. on a higher surface than a small animal needs to place its fee/paws/etc. in order to align the spine and/or esophagus of the large animal. In the embodiment shown in FIG. 1, the height of paw surface 151 may be adjusted using a set (e.g. 2, 3, 4, 5, 6, etc.) of legs 160 (referred to individually as “leg 160” or collectively as “legs 160”). Each of legs 160 of the set of legs 160 may be formed from first leg 161 and second leg 162. First legs 161 may be removably connected (e.g. threaded connection, snap fit connection, interlocking members, adhesive, pinned connection, etc.) to platform 150, and second legs 162 may be removably connected to first legs 161. The first legs 161 and/or second legs 162 of legs 160 may be removed from platform 150 to adjust the height of paw platform 151. For instance, if first legs 161 and second legs 162 are removed from platform 150, the feeding apparatus 100 may provide paw surface 151 at a height that is appropriate (e.g. causes spinal and/or esophageal alignment) for a small animal. If only second legs 162 are removed from platform 150, then feeding apparatus 100 may provide paw surface 151 at a height that is appropriate for a larger animal. If neither first legs 161 nor second legs 162 are removed from platform 150, then paw surface 151 may be provided at a height that is appropriate for a still larger animal.

The vertical adjustment of paw platform 151 is shown using two-piece connectable legs 160. However, paw platform 151 may be adjusted using removable single-piece legs (e.g. the user uses one set of legs, another set of legs, or no legs for adjustment, etc.), three-piece legs, collapsible legs, adjustable legs (e.g. containing known adjustments, like extendable/telescoping legs with pins and apertures and/or clamps to set the height, etc.), etc. Additionally, or alternatively, vertical adjustment of paw platform 151 may be accomplished without the use of legs. For example, and not limitation, platform 150 may be vertically adjustable (e.g. accordion-style design, two-piece design in which one piece slidably engages the other and is retained at a selected height, etc.). The styles of adjustment (vertical adjustment, etc.) are examples only, and the disclosure herein should not be limited to the specific types of adjustment referenced in the drawings or specification.

Feeding apparatus 100, and/or each of its components, may be formed from a material and/or materials (e.g., a metal alloy, composite, polymer, wood, plastic, etc.) of sufficient strength and rigidity to withstand the forces to support the weight of an animal (e.g. cat, dog, horse, cow, etc.) and/or feed associated with the animal as well as any static and/or dynamic loads (e.g., forces, torques, tensions, compressions, stresses, strains, etc.) imparted on feeding apparatus 100 by the animal (e.g., when moving around on feeding apparatus 100, eating from feeding apparatus 100, etc.) and/or a user when using feeding apparatus 100 (e.g. when adjusting the platforms so that the spine of an animal is properly oriented when the animal eats from the feeding apparatus 100, etc.) and/or any loads transferred between the components of the feeding apparatus. Feeding apparatus 100 may also, or alternatively, be formed from a material (e.g., stainless steel, polymer, composite, ceramic, fiberglass, etc.) of sufficient toughness and corrosion resistance and toughness to withstand exposure to chewing (e.g. of an animal) as well as exposure to water, food, saliva, cleaning solvents, etc. Additionally, or alternatively, feeding apparatus may be composed of one or more non-toxic materials (e.g. stainless steel, polymers that are FDA approved for food contact, such as polyesters, ABS plastics, etc.) to avoid injuring animals that ingest pieces of feeding apparatus 100. Feeding apparatus 100 may be of sufficient weight to provide stability to feeding apparatus 100 when being used by an animal, adjusted for an animal, and/or filled with food. Feeding apparatus 100 may come in a variety of sizes to accommodate a variety of animals. Each component of feeding apparatus 100 may be composed of one or more pieces. Alternatively, multiple components of feeding apparatus 100 may be formed as a single piece. The types and shapes of feeding apparatus 100 and its components are not intended to be limited to those shown in FIG. 1. Feeding apparatus 100 may have a wide variety of shapes and cross sections.

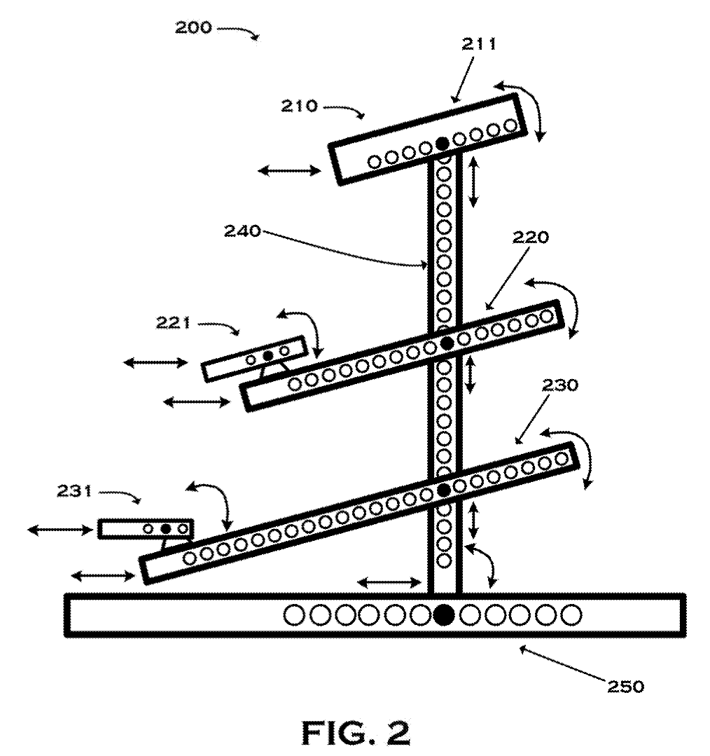

FIG. 2 illustrates a non-limiting example of a feeding apparatus 200. The feeding apparatus 200 may include a collection of components such as, for example, a first platform 210, a second platform 220, a third platform 230, a vertical member 240 and a base 250. The components illustrated in FIG. 2 are provided for explanatory purposes only, and the disclosure herein is not intended to be limited to the components provided therein. There may be additional components, fewer components, different components, or differently arranged components than illustrated in FIG. 2. Also, in some implementations, one or more of the components of the feeding apparatus 200 may perform one or more functions described as being performed by another one or more of the components of the feeding apparatus 200.

First platform 210 may be connected to vertical member 240 and may provide a feeding surface 211 for an animal. Feeding surface 211 may contain one or more apertures in which one or more feeding containers (e.g. a feed bowl, water bowl, medication container, etc.) may be placed. Additionally, or alternatively, feeding surface 211 may include one or more feeding containers formed within or as part of first platform 210. First platform 210 may be adjustable (e.g. moved horizontally in the horizontal plan (x-y plane, etc.) and/or azimuth plane, vertically in the vertical plane (x-z plane, y-z plane, etc.) and/or elevation plane, and/or rotated in yaw, elevation and/or roll angle) to accommodate any size animal and/or to allow any size animal to eat and/or drink from feeding surface 211 at a position in which the animal's spine is oriented at an angle that uses gravity to promote digestion. First platform 210 may include horizontal adjustment mechanism (e.g. pins that may be placed in selectable apertures, screws, slides, tracks, and/or some other known horizontal adjustment mechanism, etc.) that may permit first platform 210 to be adjusted from side to side, from front to back, and/or to be locked in place. First platform 210 may also, or alternatively, include a vertical adjustment mechanism (e.g. pins and selectable aperatures, screws, slides, tracks and/or some other known vertical adjustment mechanism) that may allow first platform 210 to be adjusted vertically. First platform 210 may include a rotational adjustment mechanism (e.g. pins, dials, screws, axels, bearings, and/or some other known rotational adjustment mechanism) that may allow first platform 210 to be rotationally adjusted (e.g. tilted, etc. in the elevation plane) in order to orient feeding surface 111 at an angle which permits an animal to eat and/or drink from a position in which the animal's spine is oriented to promotes digestion by allowing gravity to assist the movement of food, drink, medication, etc. from the mouth to the stomach and/or maintains food, drink, medication, etc. in the stomach, rather than in the esophagus. This orientation may cause the animal to look up from the ground, to tile the head backward, to prevent the animal from looking down at the ground when eating/drinking from the feeding apparatus 200, etc. Vertical adjustment mechanism, horizontal adjustment mechanism and/or rotational adjustment mechanism may be the same and/or separate mechanisms. Vertical adjustment mechanism, horizontal adjustment mechanism and/or rotational adjustment mechanism may be located at the connection and/or connections between first platform 210 and vertical member 240 and/or may be located in other areas of first platform 210.

Second platform 220 may be connected to vertical member 240 and may provide a front paw surface 221 on which an animal may, for example, place its front feet when feeding. Second platform 220 may include a first adjustable member that can be attached to vertical member 240 in a manner that enables the first adjustable member to be pivotably attached to vertical member 240. The pivotable attachment may permit the first adjustable member to pivot in the elevation plane to permit the height of front paw surface 221 to be increased or decreased. The first adjustable member may also, or alternatively, be attached to vertical member 240 at different heights (selectable by a user) above the surface on which feeding apparatus is placed. Front paw surface 221 may be connected to one end of the first adjustable member in a manner described below.

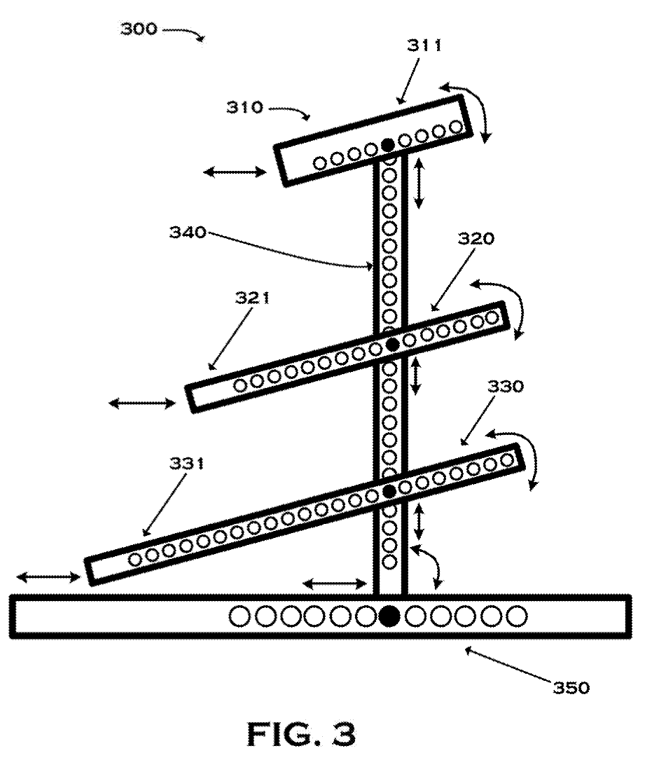

Front paw surface 221 may be elevated from the surface on which feeding apparatus 200 is placed. By way of example, an animal may place its front feet on front paw surface 221 in order to eat from feeding surface 211. Front paw surface 221 may be adjustable (e.g. moved horizontally in the horizontal plan (x-y plane, etc.) and/or azimuth plane, vertically in the vertical plane (x-z plane, y-z plane, etc.) and/or elevation plane, and/or rotated in yaw, elevation and/or roll angle) so that when the an animal places its front feet on front paw surface 221 to eat from feeding surface 211, the animal's spine is oriented at an angle that promotes digestion by aligning the spine and/or esophagus and/or by allowing gravity to assist the movement of food, drink, medication, etc. from the mouth to the stomach and/or maintains food, drink, medication, etc. in the stomach, rather than in the esophagus. Front paw surface 221 may adjust independent from second platform 220. Additionally, or alternatively, second platform 220 may be adjustable (e.g. moved horizontally in the horizontal plan (x-y plane, etc.) and/or azimuth plane, vertically in the vertical plane (x-z plane, y-z plane, etc.) and/or elevation plane, and/or rotated in yaw, elevation and/or roll angle) to accommodate any size animal and/or to align the spine of any size animal while the animal is eating from feeding surface 211. Second platform 220 may include a horizontal adjustment mechanism (e.g. pins, screws, slides, etc.) that may permit second platform 120 to be adjusted from side to side and/or from front to back. Second platform 220 may also include a vertical adjustment mechanism (e.g. pins, screws, slides, etc.) that may allow second platform 220 to be adjusted vertically. Second platform 220 may include a rotational adjustment mechanism (e.g. pins, dials, screws, hinges, bearings, etc.) that may allow second platform 220 to be rotationally adjusted (e.g. tilted, etc.) in order to place an animal's front feet at an elevation that causes the animal's spine to be oriented at an angle that promotes digestion by aligning the spine and/or esophagus to assist the movement of food, drink, medication, etc. from the mouth to the stomach and/or maintains food, drink, medication, etc. in the stomach, rather than in the esophagus when the animal eats from feeding surface 211. Additionally, or alternatively, front paw surface 221 may include horizontal, vertical and/or rotational adjustment mechanisms that may permit front paw surface 221 to move and/or rotate independent of second platform 220. Vertical adjustment mechanism, horizontal adjustment mechanism and/or rotational adjustment mechanism may be the same and/or separate mechanisms. Vertical adjustment mechanism, horizontal adjustment mechanism and/or rotational adjustment mechanism may be located at the connection and/or connections between second platform 220 and vertical member 240, between front paw surface 221 and second platform 220, and/or may be located in other areas of second platform 220 and/or front paw surface 221. Front paw surface 221 may be formed as a part of second platform 220 and/or may be a separate component. For example, as depicted in the alternative embodiment of FIG. 3, feeding apparatus 300 may include second platform 320 which may be connected to vertical member 320 and may provide the front paw surface 321 formed as a part of second platform 320. In another embodiment (not shown), feeding apparatus may include a first platform, a second platform, and a vertical member connected to the first platform and the second platform. In this embodiment, the second platform provides the front paw platform and also serves as the base of the feeding apparatus, stabilizing the feeding apparatus. In this embodiment, the second platform may include legs which may be vertically adjustable and may, similar to the function of the legs of a table, elevate second platform from the surface on which feeding apparatus is placed. In this embodiment, first platform and second platform may be adjusted (e.g. moved horizontally in the horizontal plan (x-y plane, etc.) and/or azimuth plane, vertically in the vertical plane (x-z plane, y-z plane, etc.) and/or elevation plane, and/or rotated in yaw, elevation and/or roll angle) at the connection between the vertical member and first platform and/or the connection between the vertical member and second platform to ensure that an animal's spine and/or esophagus is oriented at an angle that promotes digestion and/or maintains food, drink, medication, etc. in the stomach, rather than in the esophagus when the animal feeds from feeding surface.

Third platform 230 may be connected to vertical member 240 and may provide a back paw surface 231 on which an animal may place its back feet when feeding. Back paw surface 231 may be elevated from the surface on which feeding apparatus 200 is placed. Third platform 230 may include a first adjustable member that can be attached to vertical member 240 in a manner that enables the first adjustable member to be pivotably attached to vertical member 240. The pivotable attachment may permit the first adjustable member to pivot in the elevation plane to permit the height of back paw surface 231 to be increased or decreased. The first adjustable member may also, or alternatively, be attached to vertical member 240 at different heights (selectable by a user) above the surface on which feeding apparatus is placed. Back paw surface 231 may be connected to one end of the first adjustable member in a manner described below. By way of example, an animal may place its back feet on back paw surface 231 and/or front paw surface 221 in order to eat from feeding surface 211. If feeding apparatus 210 is correctly adjusted for an animal, the animal may place its back feet on back paw surface 231 and its front feet on front paw surface 221, which may ensure the animal's spine is oriented at an angle that promotes digestion by aligning the spine and/or esophagus to assist the movement of food, drink, medication, etc. from the mouth to the stomach and/or to maintains food, drink, medication, etc. in the stomach, rather than in the esophagus, when the animal feeds from feeding surface 211. When an animal does not place its back feet on back paw surface (e.g. the animal's feet remain on the floor, etc.), the animal's spine may not be oriented at an angle that promotes digestion by allowing gravity to assist the movement of food, drink, medication, etc. from the mouth to the stomach and/or maintains food, drink, medication, etc. in the stomach, rather than in the esophagus when the animal eats from feeding surface 211. Back paw surface 231 may be adjustable (e.g. moved horizontally in the horizontal plan (x-y plane, etc.) and/or azimuth plane, vertically in the vertical plane (x-z plane, y-z plane, etc.) and/or elevation plane, and/or rotated in yaw, elevation and/or roll angle) to fully align the animal's spine for feeding from feeding surface 211. Additionally, or alternatively, third platform 230 may be adjustable (e.g. moved horizontally in the horizontal plan (x-y plane, etc.) and/or azimuth plane, vertically in the vertical plane (x-z plane, y-z plane, etc.) and/or elevation plane, and/or rotated in yaw, elevation and/or roll angle) to accommodate any size animal and/or to ensure the animal's spine is oriented at an angle that promotes digestion by allowing gravity to assist the movement of food, drink, medication, etc. from the mouth to the stomach and/or maintains food, drink, medication, etc. in the stomach, rather than in the esophagus while the animal is eating from feeding surface 211. Third platform 230 may include a horizontal adjustment mechanism (e.g. pins, screws, slides, tracks and/or some other known horizontal adjustment mechanism, etc.) that may permit third platform 230 to be adjusted from side to side, front to back, and/or to be locked in place. Third platform 230 may also, or alternatively, include a vertical adjustment mechanism (e.g. pins, screws, slides, tracks and/or some other known vertical adjustment mechanism, etc.) that may allow third platform 230 to be adjusted vertically. Third platform 230 may include a rotational adjustment mechanism (e.g. pins, dials, screws, axels, bearings, and/or some other known rotational adjustment mechanism, etc.) that may allow third platform 230 to be rotationally adjusted (e.g. tilted, etc. in the elevation place) in order to place an animal's back feet at an elevation that properly orients the animal's spine as described herein when the animal eats from feeding surface 211. Additionally, or alternatively, back paw surface 231 may include horizontal, vertical and/or rotational adjustment mechanisms that may permit back paw surface 231 to move and/or rotate relative to third platform 230. Vertical adjustment mechanism, horizontal adjustment mechanism and/or rotational adjustment mechanism may be the same and/or separate mechanisms. Vertical adjustment mechanism, horizontal adjustment mechanism and/or rotational adjustment mechanism may be located at the connection and/or connections between third platform 230 and vertical member 240, between back paw surface 231 and third platform 230, and/or may be located in other areas of third platform 230 and/or back paw surface 231. Back paw surface 231 may be formed as a part of third platform 230 and/or may be a separate component. For example, as depicted in the alternative embodiment of FIG. 2, feeding apparatus 300 may include third platform 330 which may be connected to vertical member 340 and may provide the back paw surface 331 formed as a part of second platform 330. In one embodiment (not shown), feeding apparatus may include a first platform, a second platform, a third platform, and a vertical member connected to the first platform, the second platform and the third platform. In this embodiment, the second platform provides the front paw platform, and the third platform provides the back paw platform and also serves as the base of the feeding apparatus, stabilizing the feeding apparatus. In this embodiment, the third platform may include legs which may be vertically adjustable and may elevate second platform, similar to the function of the legs of a table, from the surface on which feeding apparatus is placed. In this embodiment, first platform, second platform and/or third platform may be adjusted (e.g. moved horizontally in the horizontal plan (x-y plane, etc.) and/or azimuth plane, vertically in the vertical plane (x-z plane, y-z plane, etc.) and/or elevation plane, and/or rotated in yaw, elevation and/or roll angle) at the connection between the vertical member and first platform, at the connection between the vertical member and second platform, and/or at the connection between the third platform and the vertical member to ensure the animal's spine is oriented at an angle that promotes digestion, for example, by allowing gravity to assist the movement of food, drink, medication, etc. from the mouth to the stomach and/or maintains food, drink, medication, etc. in the stomach, rather than in the esophagus when the animal feeds from feeding surface.

Vertical member 240 may connect first platform 210, second platform 220 and/or third platform 230 to base 250. Vertical member 240 may be connected (e.g. pins, dials, screws, axels, bearings and/or some other known rotational adjustment mechanism, etc.) to first platform 210, second platform 220, third platform 230 and/or base 250 in a way that permits rotation. Additionally, or alternatively, vertical member 240 may be connected (e.g. pins, screws, slides, tracks and/or some other known vertical and/or horizontal adjustment mechanism etc.) to first platform 210, second platform 220, third platform 230 and/or base 250 in a way that permits vertical and/or horizontal movement of the first platform 210, second platform 220 and/or third platform 230 relative to each other and/or the base 250. The connections between vertical member 240 and first platform 210, second platform 220, third platform 230 and/or base 250 may lock to prevent and/or limit movement of the feeding apparatus 200. Vertical member 240 may be adjusted to ensure the animal's spine is oriented at an angle that promotes digestion by aligning the spine and/or esophagus to prevent any turns/bumps, etc. that may impede food, liquid, medication, etc. from travelling from the mouth to the stomach. For example, vertical member 240 may rotate relative base 250 to provide feeding surface 211 at an angle (e.g. 5 degrees, 15 degrees, 45 degrees, etc.) relative to the surface on which feeding apparatus 200 is placed.

Base 250 may connect to vertical member 240 and may provide support to the feeding apparatus 200 so that it does not move (e.g. rotate, turn over, slide, etc.) when it is in use (e.g. filled with food or water, when an animal stands on feeding apparatus 200 and/or eats from feeding surface 211, etc.). Base 250 may be connected (e.g. pins, screws, etc.) to vertical member 240 in way that permits vertical member 240 to move (e.g. move horizontally, rotate, etc.) relative to base 250. Base 250 may include a foot surface (not shown), similar to front paw surface 221 and/or back paw surface 231, on which foot surface an animal may place its front feet and/or back feet when feeding from feeding surface 211. Foot surface may be adjustable (e.g. moved horizontally in the horizontal plan (x-y plane, etc.) and/or azimuth plane, vertically in the vertical plane (x-z plane, y-z plane, etc.) and/or elevation plane, and/or rotated in yaw, elevation and/or roll angle) relative to base 250 to ensure the animal's spine is oriented at an angle that promotes digestion by aligning the spine and/or esophagus. Base 250 may include legs (not shown), which may be vertically adjustable and which may function similarly to the legs of a table to elevate the feeding apparatus 200 from the surface on which it is placed. In one embodiment (not shown), feeding apparatus consists of a first platform, from which an animal may feed, a vertical member connected to the first platform and to a base, the base including a foot plane and legs. In this embodiment, a user may adjust the first platform and/or the connection between the vertical member and the base to cause an animal's spine to be oriented in a manner that uses gravity to promote digestion when the animal eats from a feeding surface associated with the first platform.

Feeding apparatus 200, and each of its components, may be formed from a material and/or materials (e.g., a metal alloy, composite, polymer, wood, plastic, etc.) of sufficient strength and rigidity to withstand the forces to support the weight of an animal (e.g. cat, dog, horse, cow, etc.) and/or feed associated with the animal as well as any static and/or dynamic loads (e.g., forces, torques, tensions, compressions, stresses, strains, etc.) imparted on feeding apparatus 200 by the animal (e.g., when moving around on feeding apparatus 200, eating/drinking from feeding apparatus 200, etc.) and/or a user when using feeding apparatus 200 (e.g. when adjusting the platforms so that the spine of an animal is properly oriented when the animal eats from the feeding apparatus 200) and/or any loads transferred between the components of the feeding apparatus. Feeding apparatus 200 may also, or alternatively, be formed from a material (e.g., stainless steel, polymer, composite, ceramic, fiberglass, etc.) of sufficient corrosion resistance and toughness to withstand exposure to water, food, saliva, cleaning solvents, etc. Feeding apparatus 200 may be of sufficient weight to provide stability to feeding apparatus 200 when being used by an animal, adjusted for an animal, and/or filled with food. Feeding apparatus 200 may come in a variety of sizes to accommodate a variety of animals. Each component of feeding apparatus 200 may be composed of one or more pieces. Alternatively, components of feeding apparatus 200 may be combined. The types and shapes of feeding apparatus 200 and its components are not intended to be limited to those shown in FIGS. 2 and 3. Feeding apparatus 200 may have a wide variety of shapes and cross sections (e.g. square, rectangle, I-Beam, etc.).

While preferred embodiments of the invention have been shown and described, those skilled in the art will recognize that other changes and modifications may be made to the foregoing embodiments without departing from the scope and spirit of the invention. For example, specific shapes of various elements of the illustrated embodiment may be altered to suit particular applications. Additionally, the feeding apparatus may have more or less platforms, legs, surfaces, adjustment mechanisms, etc. Additionally, or alternatively, various components may be added to and/or subtracted from feeding apparatus without departing from the spirit of the invention. Further, the embodiment disclosed herein may be used on any animal and in different applications. For example, the embodiment disclosed herein may be used to provide a surface for an animal for something other than feeding (e.g. grooming, digesting a meal, etc.). It is intended to claim all such changes and modifications as fall within the scope of the disclosure herein and the equivalents.

The foregoing description provides illustration and description, but is not intended to be exhaustive or to limit the implementations to the precise form disclosed. Modifications and variations are possible in light of the above disclosure or may be acquired from practice of the embodiments.

It should be emphasized that the terms comprises and comprising, when used in this specification, are taken to specify the presence of stated features, integers, steps or components but do not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A feeding apparatus for allowing an animal to eat and/or drink from a position at which the animal's spine and/or esophagus is aligned, the feeding apparatus comprising:
a vertically adjustable feeding platform having a feeding surface from which an animal may eat and/or drink, the feeding surface oriented at an angle relative to the surface of the ground on which the feeding apparatus is placed to prevent the animal from looking down and/or to cause the animal to tilt its head back when eating and/or drinking from feeding apparatus;
a vertically adjustable first platform located below the feeding platform and providing a paw surface on which an animal may place its front feet when eating and/or drinking from the feeding platform, the paw surface located above the surface of the ground on which the feeding apparatus is placed; and
a member adjustably connected to the vertically adjustable feeding platform, the member supporting the vertically adjustable feeding platform and providing for vertical adjustment of the vertically adjustable feeding platform.

2. The feeding apparatus of claim 1 further including legs connected to the vertically adjustable first platform, the legs providing for vertical adjustment of the vertically adjustable first platform.

3. The feeding apparatus of claim 2 wherein the legs are telescoping.

4. The feeding apparatus of claim 2 wherein the legs are removable.

5. The feeding apparatus of claim 2 wherein each of the legs are formed from at least two pieces.

6. The feeding apparatus of claim 1 wherein the vertically adjustable first platform is an accordion-style design.

7. The feeding apparatus of claim 1 wherein the member is connected to the feeding platform.

8. The feeding apparatus of claim 1 wherein the angle is from about 5 degrees to about 25 degrees.

9. The feeding apparatus of claim 8 wherein the angle is from about 8 degrees to about 18 degrees.

10. The feeding apparatus of claim 9 wherein the angle is from about 10 degrees to about 16 degrees.

11. The feeding apparatus of claim 1 further including one or more feeding apertures located on the feeding surface.

12. The feeding apparatus of claim 11 wherein the feeding apparatus includes exactly two feeding apertures.

13. The feeding apparatus of claim 12 including only one member located between the two feeding apertures.

14. The feeding apparatus of claim 1 wherein the angle is fixed.

15. The feeding apparatus of claim 1 wherein the angle is adjustable.

16. The feeding apparatus of claim 1 further including a second platform located above the surface of the ground on which the feeding apparatus is placed.

17. A feeding apparatus for allowing an animal to eat and/or drink from a position at which the animal's spine and/or esophagus is aligned, the feeding apparatus comprising:
a vertically adjustable feeding platform having a feeding surface from which an animal may eat and/or drink, the feeding surface oriented at a fixed angle relative to the surface of the ground on which the feeding apparatus is placed to prevent the animal from looking down and/or to cause the animal to tilt its head back when eating and/or drinking from feeding apparatus;
a first platform located below the feeding platform and providing a paw surface on which an animal may place its front feet when eating and/or drinking from the feeding platform, the paw surface located above the surface of the ground on which the feeding apparatus is placed; and
a member adjustably connected to the vertically adjustable feeding platform, the member supporting the vertically adjustable feeding platform and providing for vertical adjustment of the vertically adjustable feeding platform.

18. The feeding apparatus of claim 17 wherein the fixed angle is from about 5 degrees to about 25 degrees.

19. The feeding apparatus of claim 17 wherein the fixed angle is from about 8 degrees to about 18 degrees.

20. The feeding apparatus of claim 17 wherein the fixed angle is from about 10 degrees to about 16 degrees.

21. A feeding apparatus for allowing an animal to eat and/or drink from a position at which the animal's spine and/or esophagus is aligned, the feeding apparatus comprising:
a vertically adjustable feeding platform having a feeding surface from which an animal may eat and/or drink, the feeding surface oriented at an angle relative to the surface of the ground on which the feeding apparatus is placed to prevent the animal from looking down and/or to cause the animal to tilt its head back when eating and/or drinking from feeding apparatus;
a first platform located below the feeding platform and providing a paw surface on which an animal may place its front feet when eating and/or drinking from the feeding platform, the paw surface located above the surface of the ground on which the feeding apparatus is placed; and
a single member adjustably connected to the vertically adjustable feeding platform, the single member supporting the vertically adjustable feeding platform and providing for vertical adjustment of the vertically adjustable feeding platform.

22. The feeding apparatus of claim 21 further including two feeding apertures located on the feeding surface.

23. The feeding apparatus of claim 22 wherein the single member is located between the feeding apertures.
